(19) United States
(12) Patent Application Publication
(10) Pub. No.: US 2014/0020918 A1
(43) Pub. Date: Jan. 23, 2014

(54) Hand-Held Tool With Rotary-Oscillatory Drive

(71) Applicant: Olaf Klabunde, Giengen (DE)

(72) Inventor: Olaf Klabunde, Giengen (DE)

(21) Appl. No.: 14/034,174

(22) Filed: Sep. 23, 2013

Related U.S. Application Data
(63) Continuation of application No. PCT/EP2012/054213, filed on Mar. 12, 2012.

(30) Foreign Application Priority Data
Mar. 22, 2011 (DE) 102011015117.6

(51) Int. Cl. B23Q 5/027

(52) U.S. Cl. CPC B23Q 5/027
USPC 173/49; 173/217

(57) ABSTRACT

The invention discloses a hand-held tool having a housing with a gear head, having a motor shaft that can be driven in rotation by a motor and that can be coupled, by means of an eccentric coupling mechanism, to a tool spindle in order to drive the latter, wherein the tool spindle can be driven in an oscillatory rotating manner about the longitudinal axis thereof and is configured to receive a tool, wherein the eccentric coupling mechanism has a coupling member which is coupled to the motor shaft and to the tool spindle, and wherein the coupling member is furthermore mounted pivotably on a carrier element coupled to the housing. The carrier element is preferably capable of being moved in translation or pivoted relative to the housing.

### CROSSREFERENCES TO RELATED APPLICATIONS

This application is a continuation of International Patent Application PCT/EP2012/054213, filed on Mar. 12, 2012 designating the U.S., which International Patent Application has been published in German language and claims priority from German patent application 10 2011 015 117.6, filed on Mar. 22, 2011. The entire contents of these priority applications are incorporated herein by reference.

### BACKGROUND OF THE INVENTION

The invention relates to a hand-held tool having a housing with a gear head, having a motor shaft that can be rotatingly driven by a motor and that can be coupled, by means of an eccentric coupling mechanism, to a tool spindle in order to drive the latter, wherein the tool spindle can be driven in an oscillatory rotating manner about the longitudinal axis thereof and is configured for receiving a tool, and wherein the eccentric coupling mechanism has a coupling member which is coupled to the motor shaft and to the tool spindle.

A hand-held tool of this kind is known from WO 2008/128804 A1. This is a power tool with a drive unit for driving an input shaft, and an output shaft, on which a tool is mounted. The rotary motion of the input shaft can be transmitted to the output shaft by an eccentric coupling device.

Hand-held tools of this kind can be used, for example, for cutting or grinding workpieces, wherein the oscillatory motion of the tool is capable in principle of allowing precise guidance in combination with a high cutting or removal rate.

In the case of the known hand-held tool, the design entails that the achievable pivot angle can assume only a relatively small value within a narrow range. Here, it is, in particular, the eccentricity of the input shaft and the distance between the input shaft and the output shaft which are defining and restrictive design parameters. Thus, WO 2008/128804 A1 proposes to provide a mass balancing device between the input shaft and the output shaft, but this device requires a certain distance between the input shaft and the output shaft. Thus, the lever arm of an output shaft driver via which the input shaft acts on said output shaft is extended. As a result, there is a reduction in the pivot angle that can be achieved at the output shaft for a constant eccentricity of the input shaft.

### SUMMARY OF THE INVENTION

In view of this, it is a first object of the invention to disclose a hand-held tool with an improved oscillatory drive in which a desired pivot angle can be provided irrespective of given actual positions of the motor shaft or of the tool spindle.

It is a second object of the invention to disclose a hand-held tool with an improved oscillatory drive in which the pivot angle can be selected from a wide range with, as far as possible, small structural adaptations.

It is a third object of the invention to disclose a hand-held tool with an improved oscillatory drive that allows for a low-vibration operation of the hand-held tool.

According to one aspect of the invention, these and other objects are achieved by a hand-held tool comprising;

a housing;

a gear head received within said housing;

a motor received within said housing and having a motor shaft that is rotatingly driven by said motor;

a tool spindle received within said housing and having one end protruding from said gear head for receiving a tool;

a carrier element received on said housing;

an eccentric coupling mechanism received within said housing, said eccentric coupling mechanism being coupled to said motor shaft and to said tool spindle for driving said tool spindle in an oscillatory rotating manner about a longitudinal axis thereof, said eccentric coupling mechanism comprising a coupling member being configured as a lever or bent lever and being mounted pivotably on said carrier element, said coupling member being coupled to said motor shaft and to said tool spindle.

According to the invention the coupling member is used to provide a lever between the motor shaft and the tool spindle, allowing a desired pivot angle of the tool spindle to be achieved, even where there are differences in the positions of the motor shaft relative to the tool spindle owing to the design. In particular, it is not necessary here to adapt an eccentricity of the motor shaft to the desired pivot angle, for instance.

In other words, the coupling member can be regarded as a “rocker”, which is inserted between the motor shaft and the tool spindle. It is completely irrelevant in the case of “rocker” arms of equal length, for example, what the total length is, since a stroke motion at one end of the “rocker” is always converted into an opposing stroke motion at the other end of the “rocker”.

It is self-evident here that the coupling member can have arms of different lengths; a motion which is initiated, e.g. a motion introduced by an eccentric section of the motor shaft, is converted in accordance with the ratio of the arm lengths. In principle, this can take place irrespective of the total length of the coupling member.

In this way, the hand-held tool can be adapted to a very wide variety of conditions of use requiring, for instance, different pivot angles. At the same time, a large amount of creative freedom in the design configuration is ensured.

In addition, the configuration of the coupling member as a “rocker” can contribute to a reduction in the vibration level. The coupling member converts an input stroke, brought about, for instance, by the eccentric section of the motor shaft, into an opposing output stroke, which can bring about a pivoting of the tool spindle. This measure can produce mass balancing by virtue of the opposing displacement of masses.

According to another embodiment of the invention, the coupling member is designed as a lever or as a bent lever, wherein a bearing location for support on the carrier element is provided between two lever sections.

Thus, the relevant lever arm lengths are obtained through the distance between the bearing location and the respective coupling point to the motor shaft and to the tool spindle.

According to another aspect of the invention, the coupling member is embodied as a double fork and has contact surfaces for converting the driving motion produced by the motor into an oscillatory rotary output motion of the tool spindle.

In this case, the driving motion produced by the motor can be regarded as a revolution of the eccentric section about an axis, for instance. Here, one component of this eccentric revolution can bring about the backward and forward pivoting of the coupling member. At a tool-facing end of the double fork, the pivoting motion can be transmitted to the tool spindle.

One preferred possibility here is for the contact surfaces of each fork of the double fork to be configured so as to be parallel to one another and, as far as possible, flat. In this case, a high degree of overlap or matching in terms of shape can be ensured, thereby making it possible to avoid faults attributable to inaccuracies of fit, such as rattling or excessive wear.

It is furthermore preferred if the contact surfaces interact with suitable bearings, which are mounted on the motor shaft or, alternatively, on the tool spindle.

In addition, it is, in principle, conceivable to provide a driver fork having contact surfaces on the tool spindle, said fork interacting with a bearing mounted on the coupling member in order to transmit the pivoting motion.

As an expedient development of the invention, the carrier element can be moved relative to the housing, wherein an actuating element, which can be coupled to the carrier element in order to move the latter, is provided.

For given dimensions of the coupling member, it is possible in this way to vary the effective lever arm lengths between the bearing location and the motor shaft or the tool spindle, thus making it possible to adapt the “transmission ratio” of the coupling member. Here, it is possible in a simple manner, for a given eccentricity of the motor shaft for instance, to bring about different pivot angles simply by moving the coupling member on the tool spindle, said pivot angles making it possible to cover a wide range of possible uses. This is accomplished irrespective of the relative positions of the motor shaft and the tool spindle.

The pivot angle which is obtained at the tool spindle can be optimized, for instance, in respect of efficiency for a given application or indeed to achieve a particularly good vibration level. Even after a movement, the contact surfaces can continue to ensure contact and hence power transmission between the components involved, that is to say, for example, bearings which are mounted on the motor shaft or the tool spindle with the coupling member.

According to another embodiment of the invention, the carrier element can be moved in translation or pivoted relative to the housing.

Here, movement of the carrier element and of the coupling member mounted thereon brings about a change in the lever arm lengths between the tipping point of the “rocker” and the contact locations with the motor shaft or the tool spindle.

Pivoting can, for instance, take place about an axis which is perpendicular to a plane defined by the longitudinal axis of the tool spindle and a longitudinal axis of the motor shaft. Here too, the effective lever arm lengths can change, leading to a change in the transmission ratio between the two lever arms.

Here, the actuating element can be embodied as a threaded spindle, a linear-motion cylinder, a sliding block or similar. Actuation can be accomplished by a motor or, alternatively, by hand.

According to another embodiment, it is preferred if the movement of the carrier element can take place in an infinitely variable manner or, alternatively, at least with sufficiently small intervals, thus allowing as flexible as possible adjustment and adaptation to operating conditions that arise.

Translatory movement of the carrier element can allow a fundamentally constant adjustment characteristic. In other words, a particular adjusting stroke here fundamentally brings about a particular, constant variation in the ratio of the lever arm lengths.

When the carrier element is pivoted relative to the housing, a progressive or degressive adjustment characteristic can be achieved, depending on the initial position. In accordance with fundamentally known trigonometric functions, particular adjustment angles can here bring about particularly large or, alternatively, particularly small changes in the lever arm ratios, for instance, depending on the current pivoting position of the coupling member.

It is self-evident that the carrier element can be fixed relative to the housing after an adjustment has been performed. For this purpose, recourse can be had to tightening elements or clamping elements, for instance, and fixing by self-locking of the components involved is likewise conceivable.

In an alternative embodiment of the invention, the eccentric coupling mechanism is coupled to a mass balancing device, wherein the eccentric coupling mechanism is configured to impart to the mass balancing device a balancing motion opposed to the oscillatory rotary output motion of the tool spindle.

In this way, it is possible to bring about effective mass balancing, which can contribute to a further reduction in the vibration level during the use of the hand-held tool. In principle, the balancing motion can take the form of a pivoting motion or a translatory balancing motion.

According to a development of this embodiment, the tool spindle is coupled via a side arm to the mass balancing device in order to drive the latter.

By means of this measure, the mass balancing device can be constructed in a particularly simple manner. In this case, the driving of the mass balancing device can be effected indirectly by means of the eccentric coupling mechanism, with the latter imparting to the tool spindle a pivoting motion which can also be used to drive the mass balancing device. In this case, the balancing motion of the mass balancing device is opposed to the pivoting motion of the tool spindle, and hence the inertia forces involved can be canceled out.

According to another version of this embodiment, the mass balancing device has a mass which is mounted on a bearing piece that can be moved in translation or pivoted relative to the housing.

In a fundamentally similar manner to that in the case of movement of the carrier element of the coupling member, it is thus also possible in the case of the mass to carry out a movement to adapt the mass balancing device to intended uses and operating conditions that arise. The mass can be moved in a specific way to ensure as low as possible exposure to vibration, thus making possible prolonged work without fatigue.

It is particularly preferred here if both the mass balancing device and the eccentric coupling mechanism are of adjustable configuration, thus making it possible to select optimum operating points in respect of efficiency and the ergonomics of work by specific movement both of the coupling member and of the mass, if required.

For this purpose, it is conceivable, on the one hand, to link the movement of the mass and the movement of the coupling member in a suitable manner, with the result that only one actuating element has to be actuated to move both components. As an alternative, the two components can be configured to allow separate movement, whereby it is fundamentally possible to allow a higher flexibility.

According to another aspect of the invention, the coupling member and at least the motor shaft or the tool spindle are coupled to one another by at least one convex bearing.

Even in the case of tilting between components connected to the bearing, a convex or spherical bearing allows adequate contact, thus making it possible to avoid increased stresses, jamming or even increased play at the bearing seat. The tool spindle, in particular, can adopt certain skewed positions relative to the coupling member during operation, owing to the pivoting motion, and in this case a convex bearing can ensure reliable and wear-free power transmission.

According to another embodiment of the invention, the coupling member can be pivoted about an axis which is arranged substantially parallel to the motor shaft.

According to an alternative embodiment, the coupling member can be pivoted about an axis which is arranged substantially perpendicular to the motor shaft.

Thus, the eccentric coupling device can be integrated into a very wide variety of initial configurations and installation spaces.

According to another aspect of the invention, the mass can be pivoted about an axis which is arranged substantially parallel to the motor shaft.

In an alternative embodiment, the mass can be pivoted about an axis which is arranged substantially perpendicular to the motor shaft.

The mass balancing device with the mass can thus also be integrated into the available installation space in a particularly flexible manner.

According to another embodiment of the invention, the coupling member has a mass accumulation for mass balancing.

In this way, the aim of operation of the hand-held tool with as little vibration as possible can be pursued right from the design stage of the coupling member. Here, the mass accumulation can be provided approximately at a point on the coupling member which lies opposite an imaginary distance between the center of gravity of the tool spindle, possibly provided with a tool, and the longitudinal axis thereof.

This measure can be provided in addition or as an alternative to the separate mass balancing device.

According to another aspect of the invention, the tool spindle has a side arm which is designed as a driver fork and is coupled to a bearing mounted on a tool-facing end of the coupling member.

It is thus possible to continue to provide two fork pieces, although only one thereof is formed on the coupling member for coupling to the motor shaft. The other coupling piece can be arranged on the tool spindle and be coupled to a bearing, in particular a convex bearing, provided on the coupling member.

It is self-evident that the features mentioned above and those which remain to be explained below can be used not only in the respectively indicated combination but also in other combinations or in isolation without exceeding the scope of the present invention.

### BRIEF DESCRIPTION OF THE DRAWINGS

Further features and advantages of the invention will emerge from the following description of a number of preferred illustrative embodiments with reference to the drawings, in which:

FIG. 1 shows a perspective view of a hand-held tool according to the invention;

FIG. 2 shows a simplified section through the hand-held tool shown in FIG. 1 in the region of the gear head;

FIG. 3 shows a simplified section through the hand-held tool shown in FIG. 2 along the line III-III;

FIG. 4 shows a simplified symbolic representation, in perspective, of the configuration of the hand-held tool shown in FIG. 2;

FIGS. 5a, 5b show two simplified symbolic representations of a coupling member and resulting lever arm lengths along two possible positions of movement;

FIG. 6 shows a simplified representation of a section through a gear head of an alternative hand-held tool according to the invention;

FIG. 7 shows a simplified section through the hand-held tool shown in FIG. 6 along the line VII-VII;

FIG. 8 shows a simplified symbolic representation, in perspective, of the configuration of the hand-held tool shown in FIG. 6;

FIG. 9 shows a simplified symbolic representation, in perspective, of the configuration of a hand-held tool modified relative to that shown in FIG. 8;

FIG. 10 shows another simplified section through a gear head of an alternative hand-held tool;

FIG. 11 shows a section through the hand-held tool shown in FIG. 10 along the line XI-XI;

FIG. 12 shows a simplified section through another alternative hand-held tool according to the invention in the region of the gear head;

FIG. 13 shows a simplified section through the hand-held tool shown in FIG. 12 along the line XIII-XIII;

FIGS. 14a, 14b show simplified representations of two further alternative positions of the eccentric coupling mechanism of the hand-held tool shown in FIG. 12;

FIG. 15 shows a simplified section through yet another alternative hand-held tool according to the invention in the region of the gear head;

FIG. 16 shows a simplified section through the hand-held tool shown in FIG. 15 along the line XVI-XVI;

FIG. 17 shows a simplified symbolic representation, in perspective, of the hand-held tool shown in FIG. 15;

FIG. 18 shows two views of a coupling member suitable for use in a hand-held tool according to the invention; and

FIG. 19 shows two views of an alternative coupling member suitable for use in a hand-held tool according to the invention.

### DETAILED DESCRIPTION OF THE INVENTION

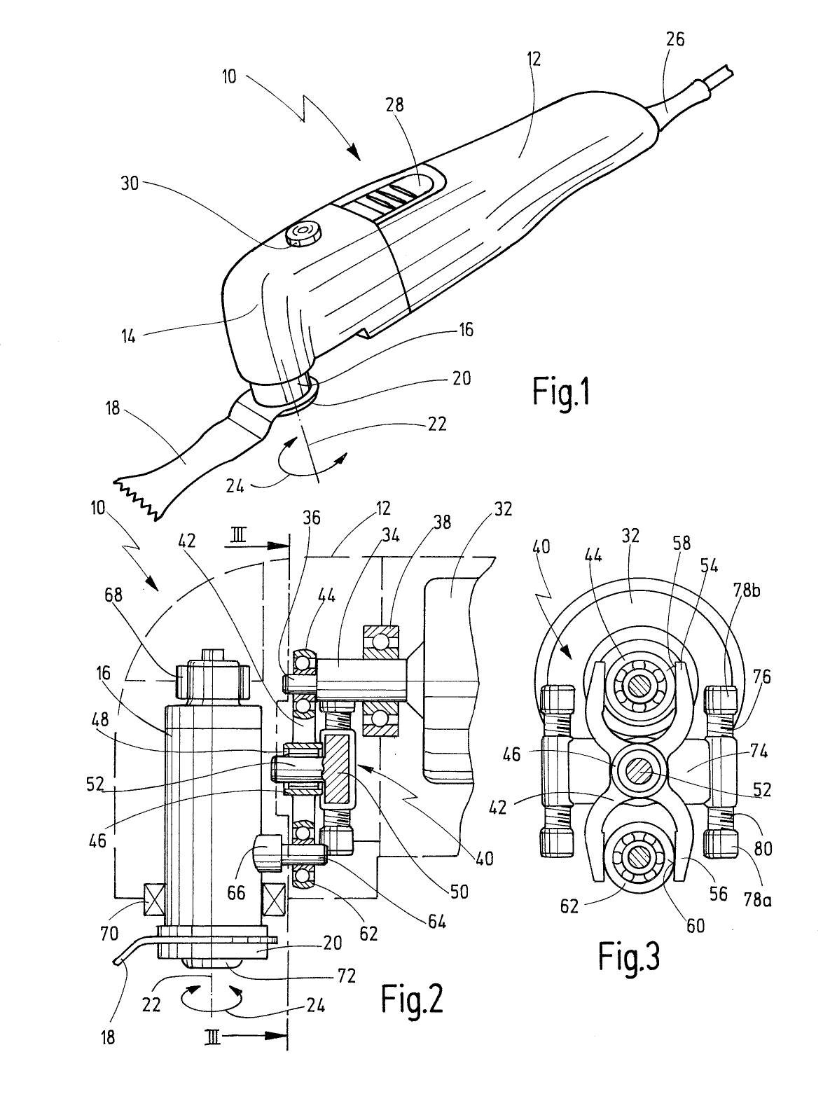

A hand-held tool according to the invention is shown in FIG. 1 and is denoted overall by the reference sign 10.

The hand-held tool 10 has a housing 12 and, in the front region thereof, a gear head 14, in which a tool spindle 16, to which a tool 18 is assigned, is mounted. In the present case, this is a tool for cutting or sawing.

The tool 18 is fixed on a tool receptacle at one end of the tool spindle 16 by means of a tool fastening 20. During the operation of the hand-held tool 10, the tool spindle 16 can be pivoted by a small angle, e.g. 0.5° to 7°, about the longitudinal axis 22 thereof at a high frequency, e.g. 5,000 to 30,000 oscillations per minute, in order to drive the tool 18. This oscillatory rotary motion is indicated by a double arrow denoted by 24.

Hand-held tools with an oscillatory rotary drive can be used for cutting but likewise also for grinding, sawing and for filling or polishing applications. The characteristic of the drive, namely small pivot angles and a high pivoting frequency, allows precise and energy saving work, especially in restricted spatial conditions, e.g. when making flush cuts or grinding at angles or in corners.

An operator can pick up the hand-held tool 10 by a grip region on the housing 12 and selectively activate or deactivate said tool by means of an operating switch 28. A supply lead, indicated by reference sign 26, can be used to supply energy to a drive motor. It is self-evident that the hand-held tool 10 can also be of cordless design instead of having an energy supply dependent on a lead. An energy supply by means of batteries, in particular, is suitable for this purpose. Driving by means of compressed air, for example, is also conceivable as well.

An adjusting switch 30 is furthermore provided on the housing 12 of the hand-held tool 10, and this switch can be used to set a suitable oscillation characteristic, in particular a pivot angle which matches the conditions of use encountered as well as possible. Depending on factors such as tool parameters, in particular characteristics of the material of the workpiece, the tool geometries, e.g. the type and size or condition of the teeth of a cutting tool or the grain size in the case of a grinding tool, and preferences or habits of an operator, e.g. rapid feed at high power or slow feed with reduced power, the optimum pivot angle can vary. Thus, an adjustable pivot angle can fundamentally improve the efficiency of the hand-held tool 10 in combination with increased work output.

As an alternative or in addition, the adjusting switch 30 can also be provided for the purpose of influencing vibration compensation devices provided in the hand-held tool 10. Fundamentally, the high-frequency oscillatory rotary motion of the tool 18 on the tool spindle 16 can be associated with exposure to vibration which, in turn, may be felt by the user and have a disadvantageous effect on the ergonomics of working, depending on various boundary conditions. By means of the adjusting switch 30, it is possible, for instance, to influence a mass balancing device in order to be able to effect mass balancing as far as possible.

It is self-evident that a plurality of adjusting switches can be provided on the hand-held tool 10 in order to be able to provide the abovementioned functions. In addition, other functions to be controlled are readily conceivable, e.g. the influencing of the frequency of oscillation of the tool spindle 16.

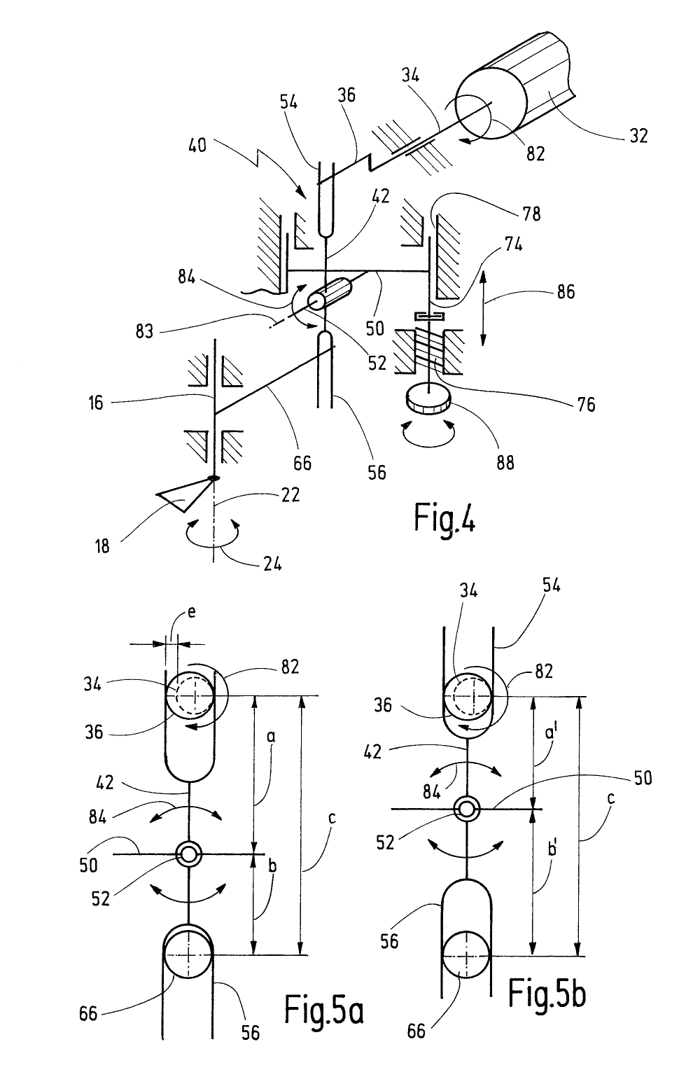

In FIG. 2, the hand-held tool 10 is shown in section in the region of the gear head 14. For the sake of clarity, the housing 12 is indicated only by a dashed line in FIG. 2, whereas, in FIG. 3, which shows a section through an arrangement in FIG. 2 along the line III-III, the housing 12 is not depicted, for the sake of simplicity. FIG. 4 shows a simplified perspective representation of the arrangement in FIGS. 2 and 3, which is based on symbolic mechanism diagrams.

In FIG. 2, a motor 32 mounted in the housing 12 by means of a motor bearing 38 is indicated. The motor 32 drives a motor shaft 34, which is arranged substantially perpendicular to the tool spindle 16. An eccentric section 36 is arranged at that end of the motor shaft 34 which faces the tool spindle 16, cf. also FIG. 4. As the motor shaft 34 revolves, cf. the arrow indicated by 82 in FIG. 4, the eccentric section 36 is moved on an eccentric path, and this motion serves to drive an eccentric coupling mechanism 40.

It is furthermore self-evident that the eccentric coupling mechanism 40 can in principle also be driven by means of additional shafts, which are inserted between the motor shaft 34 and the eccentric coupling mechanism 40 and which have an eccentric section 36. In this way, it is possible to take account of any installation space requirements which arise or of other boundary conditions which may, for instance, require a configuration of the position and orientation of the motor shaft 34 and of the tool spindle 16 relative to one another which deviates from the arrangement in FIG. 2.

The eccentric coupling mechanism 40 has a coupling member 42, which is in the form of a double fork, for instance. The eccentric section 36 of the motor shaft 34 is coupled to the coupling member 42 by an eccentric bearing 44 to enable motion to be transmitted. The revolution of the eccentric section 36 causes the coupling member 42 to pivot.

In this arrangement, the coupling member 42 can pivot about a carrier journal 52 of a carrier element 50. For mounting on the carrier journal 52, the coupling member 42 has a bearing location 46, which, in the present case, by way of example, is arranged centrally, for instance, and in which a coupling member bearing 48 associated with the carrier journal 52 is mounted.

As can be seen from FIG. 3, the coupling member 42 can have a fork 54 on the motor side and a fork 56 on the spindle side. Mutually opposite, substantially parallel contact surfaces 58, which are in operative connection with the eccentric bearing 44, are provided on the motor-side fork 54. As a departure from the illustration in FIG. 2, it is also possible, as an alternative, for the eccentric bearing 44 to have a cylindrical outer contour since, in the embodiment shown in FIGS. 2, 3 and 4, both the revolution of the eccentric section 36 and also the pivoting of the coupling member 42 take place substantially in the same plane. If a convex or spherical configuration is implemented in the eccentric bearing 44, the contact surfaces 58 of the motor-side fork 54 which correspond to it can be adapted thereto to improve maintenance of contact, i.e. can each have a mutually parallel trough-shaped extent, for instance. In the case of a convex bearing, for instance, it is possible in this way to effect line contact rather than point contact, thereby making it possible to reduce the surface pressure on the components involved.

In particular, the coupling member 42 can be of symmetrical configuration, wherein contact surfaces 60 are likewise provided on the spindle-side fork 56, said surfaces interacting with a spindle-side bearing 62, which is coupled to the tool spindle 16. The spindle-side bearing 62 is mounted on a side arm 66 of the tool spindle 16 by means of a journal 64. The spindle-side bearing 62 is advantageously designed as a convex or spherical bearing, which tolerates a certain tilting between the journal 64, which is coupled to an inner ring of the spindle-side bearing 62, and the contact surfaces 60, which are coupled to an outer ring of the spindle-side bearing 62. Such tilting can be brought about, for instance, by the oscillating pivoting motion of the tool spindle 16. Here, the usual pivot angles amount to just a few degrees. It is self-evident that, instead of having a convex outer ring, as indicated in FIG. 2, the spindle-side bearing 62 can have a convex inner ring as an alternative. In this way too, a certain amount of tilting can be compensated for.

It is preferred if at least the eccentric bearing 44 or the spindle-side bearing 62 is mounted with as little play as possible in the motor-side fork 54 and the spindle-side fork 56, respectively. It is thereby possible to reduce or even completely avoid rattling during the backward and forward motion of the coupling member 42. This can contribute to low-noise and low-wear operation.

The desired freedom from play or lack of play can be achieved in the context of manufacture, for instance, by means of suitable fits and tolerances. The use of so-called insert rolling bearings is likewise possible. In addition, a lack of play or freedom from play can in principle be achieved by means of resilient elements. Thus, the inherent elasticity of the fork-shaped coupling member 42, for instance, can be used to mount the eccentric bearing 44 and the spindle-side bearing 62 under a slight preload and without play between the fork arms of the motor-side fork 54 and of the spindle-side fork 56, respectively.

The tool spindle 16 is mounted in the housing 12 of the hand-held tool 10 by means of spindle bearings 68, 70, which are illustrated in simplified form. The tool fastening 20 for fastening the tool 18 is fixed on the tool spindle 16 by means of a fastening element 72, e.g. a clamping element, a fastening screw or a tightening device.

In principle, the carrier element 50, on the carrier journal 52 of which the coupling member 42 is pivotably mounted, can be arranged in the housing 12 in a manner fixed relative to a frame. By means of such an embodiment, a reversal of the orientation of pivoting between the eccentric section 36 of the motor shaft 34 and the side arm 66 of the tool spindle 16 can be achieved by means of a “rocker” embodied by the coupling member 42. Simply by this expedient, the operating behavior, in particular the vibration level, of the hand-held tool 10 can be influenced in an advantageous way.

In addition, appropriate design of the length of the motor-side fork 54 and of the spindle-side fork 56 can be used to effect step-up ratio or reduction ratio of the input pivoting stroke brought about by the revolution of the eccentric section 36 into an output pivoting stroke which is transmitted via the spindle-side bearing 62 to the side arm 66 of the tool spindle 16.

It may furthermore be preferred here, as an alternative, to configure the carrier element 50 with the carrier journal 52 to be movable relative to the housing 12 in order to influence the step-up ratio brought about by the coupling member 42 by varying the effective arm lengths of the motor-side fork 54 and of the spindle-side fork 56.

Such a configuration is explained below with reference to FIGS. 3, 4, 5a and 5b.

In FIG. 3, carrier element 50 is of movable design. For this purpose, a main body 74 is provided, which interacts with at least one spindle 76 mounted on at least one guide element 78. Here, the guide element 78 can be mounted on the housing 12 in a manner fixed relative to a frame. By means of a suitable drive (not shown in FIG. 3), the spindle 76 can be driven, e.g. by means of a thread 80. A threaded spindle of this kind can interact with a mating thread provided on the main body 74 in order to move the carrier element 50.

FIG. 4 shows schematically a configuration which is fundamentally suitable for this purpose, in which the motor 32 drives the motor shaft 34 with the eccentric section 36 in rotation in the manner explained above, as indicated by the arrow denoted by 82. The eccentric section 36 acts on the motor-side fork 54 of the coupling member 42 and thus drives the eccentric coupling mechanism 40. The coupling member 42 is mounted on the carrier journal 52 of the carrier element 50 and can be pivoted about a pivoting axis 83, as indicated by a double arrow denoted by 84. This pivoting motion is transmitted to the side arm 66, which is coupled to the tool spindle 16 and which is in operative connection with the spindle-side fork 56 of the coupling member 42. A pivoting motion is thus imparted to the tool spindle 16 and the tool 18 is driven in an oscillatory rotary motion about the longitudinal axis 22, cf. also the double arrow 24. In FIG. 4, an actuating element 88 is provided by way of example for moving the carrier element 50, which actuating element can be driven manually or, alternatively, by motor, for instance. The actuating element 88 acts on the spindle 76, which can be embodied as a threaded spindle, for instance. The spindle 76 is coupled to the main body 74 of the carrier element, said body being mounted on the guide element 78. As indicated by a double arrow denoted by 86, it is fundamentally possible for the carrier element 50 to be moved backward and forward in translation. During this process, the effective lever arm lengths of the coupling member 42 vary. The actuating element 88 can be coupled to the adjusting switch 30, cf. FIG. 1. As an alternative or in addition, the actuating element 88 can be controlled by means of an internal control device in the hand-held tool 10.

It is self-evident that other linear drives can be used to implement the movement of the carrier element 50 as an alternative to a threaded spindle, for instance. These can be linear motors, linear cylinders, rack and pinion mechanisms, worm gears or the like, for instance. To fix a particular desired position of the carrier element 50, suitable clamping elements or actuating elements can be provided.

Two possible positions of movement of the carrier element 50 are illustrated in FIGS. 5a and 5b. Here, a distance c corresponds to the distance between the motor shaft 34 and the side arm 66. The distance c remains constant, even during the movement of the carrier element 50. a denotes the distance between the motor shaft 34 and the carrier journal 52 of the carrier element 50, while a distance b indicates the distance between the carrier journal 52 and the side arm 66. In the position of the carrier element 50 which is shown in FIG. 5a, a stroke brought about by an eccentricity e of the eccentric section 36 is thus converted in accordance with the ratio of a to b into a correspondingly small output stroke, which causes the side arm 66 to pivot. In FIG. 5b, in contrast, the carrier element 50 has moved into a position in which a modified distance a′ between the motor shaft 34 and the carrier journal 52 is smaller than a modified distance b′ between the carrier journal 52 and the side arm 66. It is thus possible, for instance, to bring about a correspondingly enlarged stroke of the side arm 66.

Other transmission ratios are readily conceivable and, in principle, can be selected in a continuously variable manner. In this case, the ratio of a to b can, for instance, be varied in a range of approximately 1.1:1 to approximately 1:1.1, preferably in a range of approximately 1.3:1 to 1:1.3, more preferably in a range of approximately 1.5:1 to 1:1.5. Other ratio spreads are conceivable, in principle.

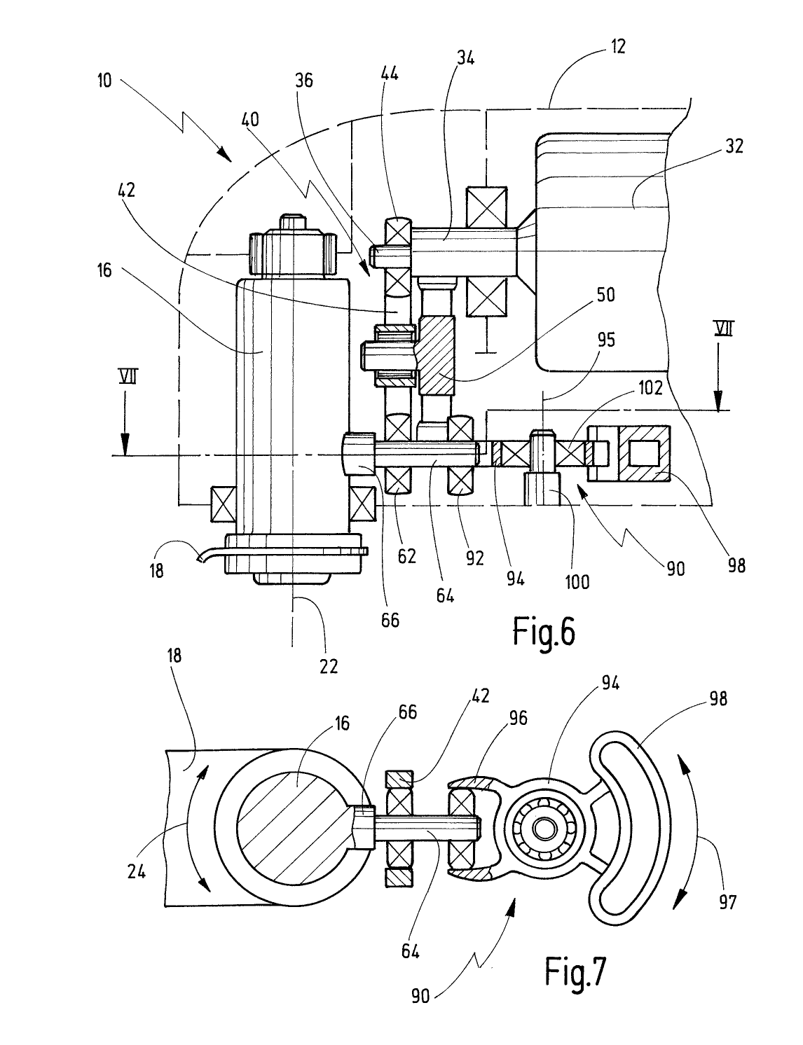

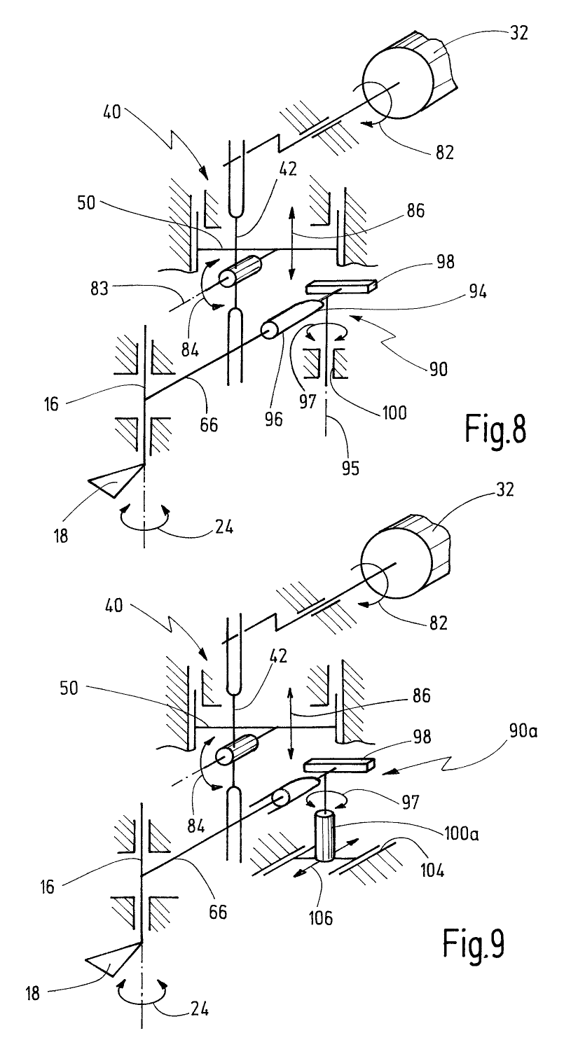

Another embodiment of the hand-held tool 10, the basic construction of which corresponds to the arrangement shown in FIG. 2, is illustrated in FIGS. 6 and 7. As a supplement thereto, a corresponding perspective representation by means of symbolic mechanism diagrams is shown in FIG. 8.

In this case, the arrangement is additionally provided with a mass balancing device 90, which interacts with the eccentric coupling mechanism 40 via a coupling bearing 92, which is arranged on the journal 64 of the side arm 66 of the tool spindle 16. The coupling bearing 92 can be embodied as a convex bearing. The mass balancing unit 90 furthermore has a mass 94, which is provided with a fork 96 that interacts with the coupling bearing 92. At the end thereof facing away from the fork 96, the mass 94 has a balance weight 98. The mass 94 is mounted on a bearing piece 100 by means of a pivot bearing 102.

Viewing FIGS. 7 and 8 together, it is apparent that a pivoting motion of the coupling member 42 brought about by the revolving eccentric section 36 of the motor shaft 34 is transmitted via the spindle-side bearing 62 to the side arm 66, wherein a corresponding pivoting motion is imparted to the tool spindle 16. In addition, the side arm 66 furthermore acts via the journal 64 as a drive for the coupling bearing 92, which imparts to the mass balancing device 90, in particular to the mass 94 with the balance weight 98, a pivoting motion which corresponds to the pivoting motion of the tool spindle 16 but which is opposed to the latter. During this process, the mass 94 oscillates about an axis 95, as indicated by a double arrow denoted by 97, cf. FIG. 8. Here, the double arrows 97 and 24 are mutually opposed.

The bearing piece 100 of the mass balancing device 90 can be mounted on the housing 12 of the hand-held tool 10 in a manner fixed relative to a frame. As an alternative, it may be preferred if the bearing piece 100 is capable of being moved relative to the housing 12 in order to be able to adjust the degree of mass compensation in as variable a manner as possible to operating conditions which arise. A construction of this kind is illustrated schematically in FIG. 9.

In this case, the embodiment is oriented fundamentally with reference to FIG. 8, wherein, instead of the bearing piece 100 fixed relative to a frame, a movable bearing piece 100a is provided, which can be moved along a guide 104 in the housing 12 of the hand-held tool, as indicated by a double arrow denoted by 106. For a given pivot angle of the tool spindle 16, the movement means that the pivot angle of the mass 94 is modified. At a given oscillation frequency, this measure leads to higher or lower angular acceleration by the mass 94, in particular the balance weight 98. It is thus possible selectively to provide a high counter torque when using a particularly large, inert tool 18, for instance, making it possible to achieve effective canceling out of the vibrations caused by the oscillating masses.

In principle, it is conceivable here to embody the bearing piece 100 of the mass balancing device in a manner similar to the adjustable carrier element 50 of the eccentric coupling mechanism 40, cf. FIG. 3 and FIG. 4, for instance.

It is particularly preferred if, as shown in FIG. 9, for instance, both the eccentric coupling mechanism 40 and the mass balancing device 90 are adjustable or movable. Thus, the hand-held tool 10 can be matched to the intended application in a particularly suitable manner.

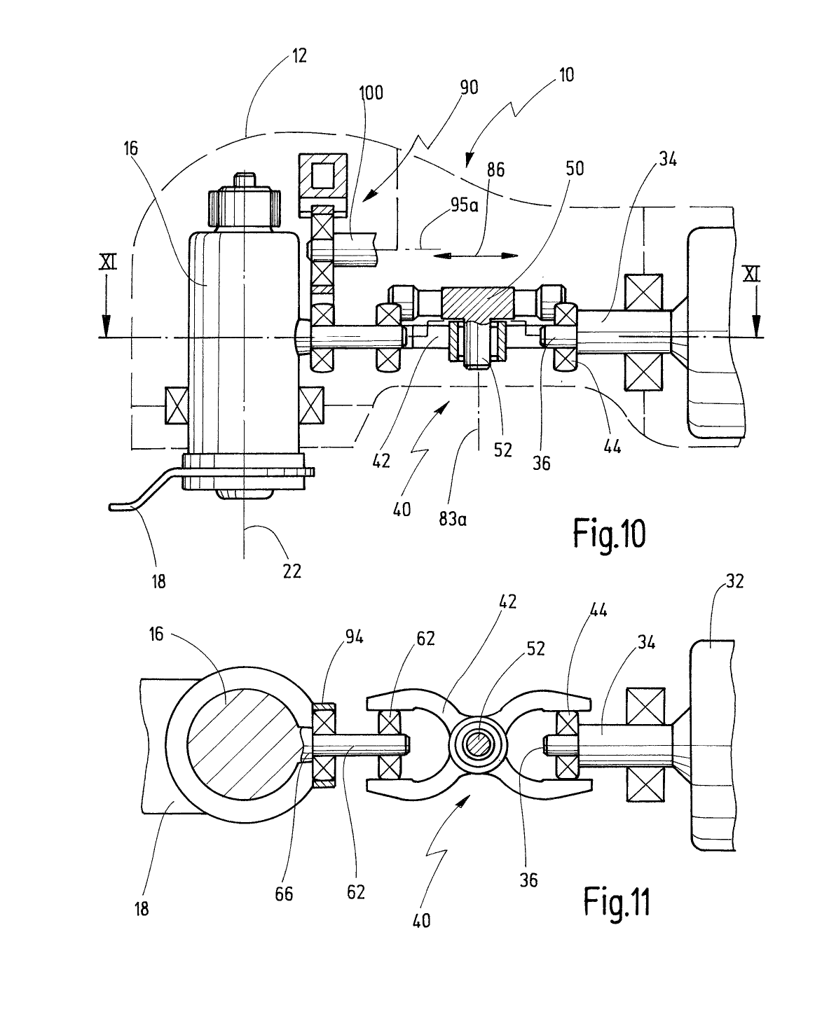

FIGS. 10 and 11 show an alternative configuration of the hand-held tool 10, which is appropriate, for instance, when the motor shaft 34 is intended to be substantially in alignment with the plane in which the side arm 66 of the tool spindle 16 is pivoted. In this case, the coupling member 42 of the eccentric coupling mechanism 40 can be arranged so as to be pivotable about a pivoting axis 83 arranged substantially parallel to the longitudinal axis 22 of the tool spindle 16. In principle, the components of the eccentric coupling mechanism 40 can be designed in a manner similar to the embodiment shown in FIGS. 2 and 3. Both the eccentric bearing 44 and the spindle-side bearing 62 are preferably designed as convex or spherical bearings.

The embodiment shown in FIGS. 10 and 11 is also assigned a mass balancing device 90, the components of which can correspond to the embodiment shown in FIGS. 6 and 7, for instance. The mass balancing device 90 can also be arranged either on a bearing piece 100 fixed relative to a frame or on a movable bearing piece 100a, as shown in FIG. 9.

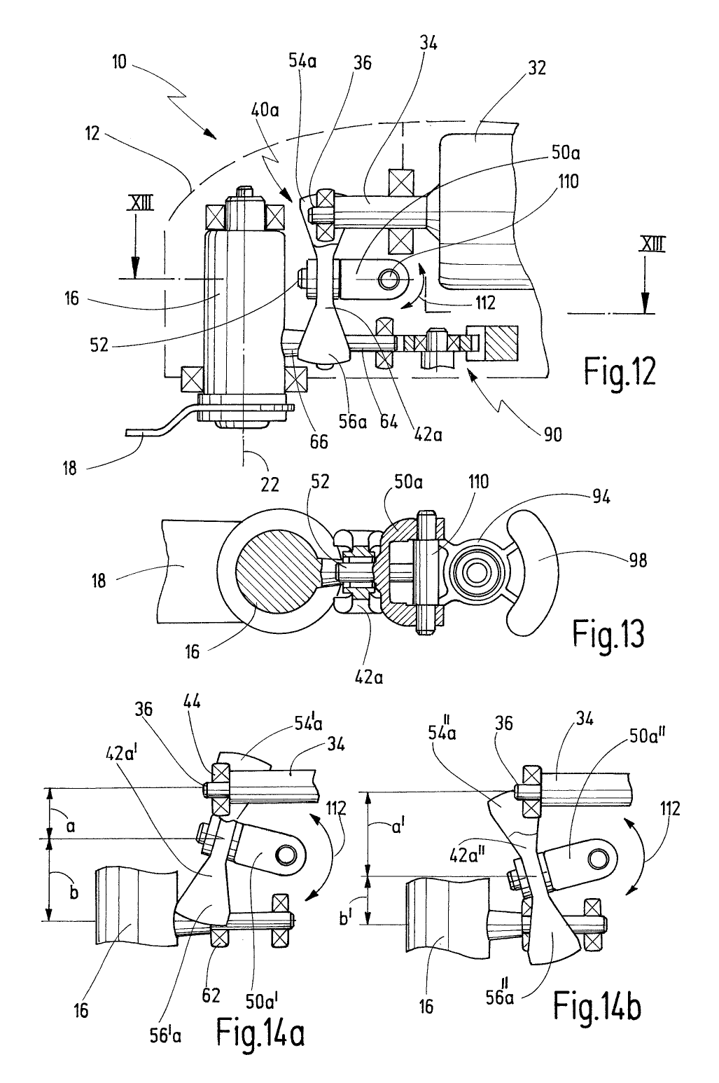

Another embodiment of a hand-held tool 10 is illustrated in FIGS. 12, 13, 14a and 14b, said tool having an alternative eccentric coupling mechanism 40a. Here, transmission of the stroke brought about by the revolution of the eccentric section 36 to the side arm 66 of the tool spindle 16 is accomplished fundamentally in accordance with the abovementioned embodiments.

Here, however, the coupling member 42a is mounted in a special way on a carrier element 50a, which can be pivoted relative to the housing 12 of the hand-held tool 10 about a pivoting axis 110 in order to vary the transmission ratio between the input stroke and the output stroke in a suitable manner.

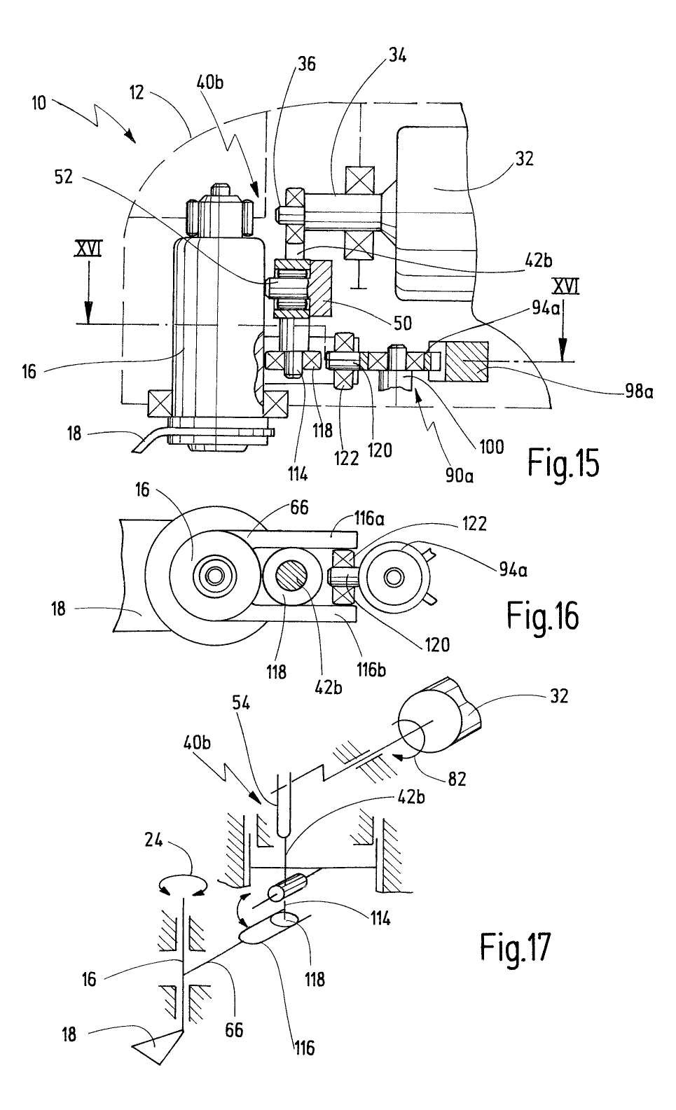

Here, the coupling member 42a has the shape of a double fork, wherein the motor-side fork 54a and the spindle-side fork 56a are widened in a fan shape toward the outside. Thus, there is still a sufficient overlap between the motor-side fork 54a and the eccentric bearing 44 and between the spindle-side fork 56a and the spindle-side bearing 62, even in the case of large pivot angles of the carrier element 50a relative to the housing 12, cf. also FIG. 14a. In FIG. 12, the carrier element 50a is positioned approximately in a normal position, whereas, in FIG. 14a, the carrier element 50a′ has clearly been deflected clockwise and, in FIG. 14b, the carrier element 54a″ has clearly been deflected counterclockwise. The pivoting of the carrier element 50a is illustrated by a double arrow denoted by 112. Viewing FIGS. 14a and 14b together with FIGS. 5a and 5b, it becomes apparent that pivoting of the carrier element 50a can also bring about variation in the transmission ratio of the coupling member 42a. The remaining configuration of this illustrative embodiment can fundamentally correspond to the configuration of the above-mentioned embodiments.

FIGS. 15 and 16 shows another illustrative embodiment, in which an eccentric coupling mechanism 40b is provided, said mechanism having a coupling member 42b which has a motor-side fork 54 at its end facing the eccentric section 36 of the motor shaft 34, cf. also the simplified symbolic representation in FIG. 17. At the end facing the side arm 66 of the tool spindle 16, in contrast, the coupling member 42b has a bearing journal 114, on which a spindle coupling bearing 118 is mounted, which interacts with fork arms 116a, 116b associated with the side arm 66 of the tool spindle 16. Here, the bearing journal 114 is arranged in the neutral position shown in FIG. 15, substantially parallel to the tool spindle 16.

This embodiment furthermore has a mass balancing device 90a, which is provided with a mass 94a that has a journal 120, which interacts via a coupling bearing 122 with the fork arms 116a, 116b of the side arm 66 of the tool spindle 16. In this case, just a single fork embodied by the fork arms 116a, 116b of the side arm 66 can interact both with the eccentric coupling mechanism 40b and with the mass balancing device 90a. In FIG. 17, the mass balancing device 90a has not been illustrated for the sake of clarity.

An embodiment of this kind too can have a carrier element 50 that can be moved relative to the housing 12. The bearing piece 100 on which the mass 94a is mounted can likewise be moved relative to the housing 12. This can be accomplished in accordance with the abovementioned illustrative embodiments, for instance.

The embodiment illustrated in FIGS. 15, 16 and 17 furthermore has the special feature that, when the carrier element 50 is moved, in accordance with FIGS. 5a, 5b and FIGS. 14a, 14b, for instance, the distance b shown there is not varied since the coupling bearing 118 remains enclosed by the fork arms 116a, 116b, even when the carrier element 50 is moved, and, as a result, the relevant lever arm with respect to the carrier journal 52 does not change in the process. In contrast, both the distance a corresponding to the distance between the motor shaft 34 and the carrier journal 52 and the distance c corresponding to the distance between the motor shaft 34 and the coupling bearing 118 are modified during a movement of the carrier element 50. In this way too, suitable transmission ratios can be brought about at the coupling member 42b, resulting in a desired pivot angle at the tool spindle 16.

The remaining configuration of this illustrative embodiment can also be oriented with reference to the abovementioned explanations.

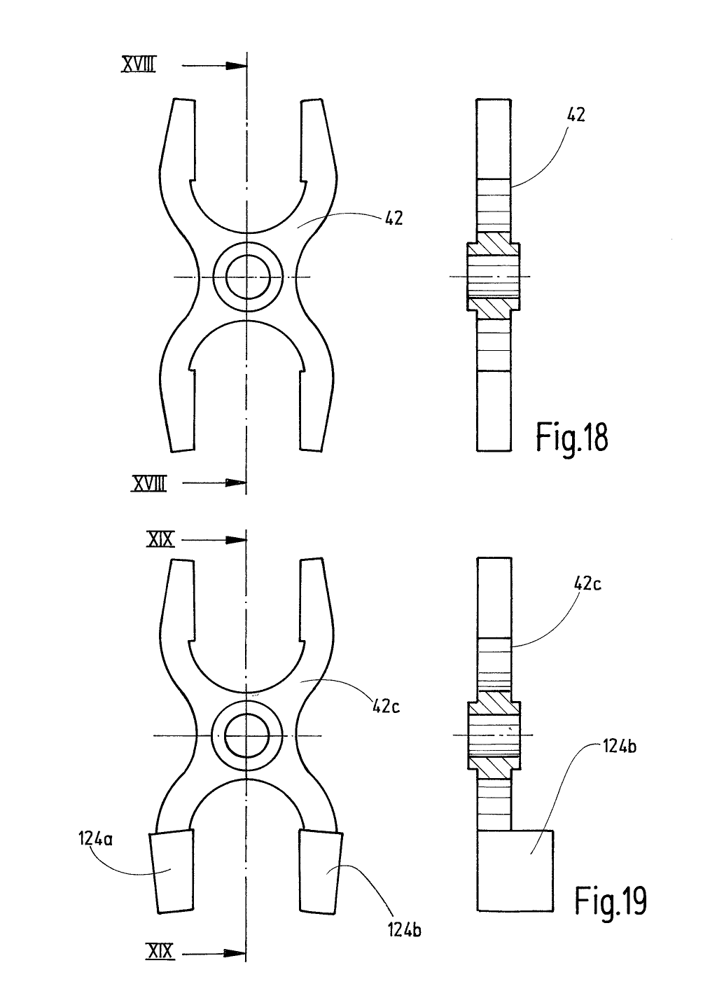

FIGS. 18 to 19 show two coupling members 42 and 42c, in each case from the front and in a sectioned view. Coupling member 42 is of substantially symmetrical configuration both longitudinally and transversely. By means of this measure, it is possible significantly to simplify manufacture. The risk of incorrect assembly can be greatly reduced.

As an alternative, the coupling member 42c is provided with an asymmetrical configuration. For this purpose, a mass accumulation 124a, 124b is provided in the region of one fork. In principle, the mass accumulation 124a, 124b can be formed on the motor-side fork 54 or on the spindle-side fork 56, cf. in this respect FIG. 3, for instance. The mass accumulation 124a, 124b can be formed as a structural thickening in the region of the fork, for instance. In this way, mass balancing for the reduction of vibrational loads can be accomplished simply through the configuration of the coupling member 42c.

If the mass accumulation 124a, 124b is associated with the motor-side fork 54, the mass unbalance introduced by the eccentric section 36 can be reinforced in order to counteract the tool spindle 16—which is fundamentally driven in opposition thereto by the eccentric coupling mechanism 40. Alternatively, arrangement of the mass accumulation 124a, 124b on the spindle-side fork 56 can bring about reinforcement of the inertia forces caused by the tool spindle 16 and the tool 18 fastened thereto. The precise arrangement of the mass accumulation 124a, 124b can take account of the geometry of the tool 18 and of the respective position of the tool 18 relative to the tool spindle 16, in particular the angular orientation of the fastened tool 18.

1. A hand-held tool comprising;
a housing;
a gear head received within said housing;
a motor received within said housing and having a motor shaft that is rotatingly driven by said motor;
a tool spindle received within said housing substantially perpendicularly to said motor shaft and having one end protruding from said gear head for receiving a tool;
a carrier element received on said housing;
an eccentric coupling mechanism received within said housing, said eccentric coupling mechanism being coupled to said motor shaft and to said tool spindle for driving said tool spindle in an oscillatory rotating manner about a longitudinal axis thereof, said eccentric coupling mechanism comprising a coupling member being configured as a lever and being mounted pivotably on said carrier element, said coupling member being coupled to said motor shaft and to said tool spindle; and
a mass balancing arrangement being coupled to said eccentric coupling mechanism and being configured to impart to said eccentric coupling mechanism a balancing motion opposed to an oscillatory rotary output motion of said tool spindle.

2. The hand-held tool of claim 1, wherein said coupling member comprises two lever sections between which there is provided a bearing location for supporting said coupling member on said carrier element.

3. The hand-held tool of claim 1, wherein said coupling member is configured as a double fork comprising contact surfaces cooperating with said motor shaft for converting a driving motion produced by said motor shaft into an oscillatory rotary output motion of said tool spindle.

4. The hand-held tool of claim 1, further comprising an actuating element being coupled to said carrier element for moving said carrier element relative to said housing.

5. The hand-held tool of claim 4, wherein said carrier element is configured for translational or pivoting movement relative to said housing.

6. The hand-held tool of claim 1, wherein said tool spindle further comprises a side arm being configured for driving said mass balancing arrangement.

7. The hand-held tool of claim 1, wherein said mass balancing arrangement comprises a balancing mass being mounted on a bearing piece that can be moved in translation or pivoted relative to said housing.

8. The hand-held tool of any of claim 7, wherein said balancing mass is arranged pivotably about an axis being arranged substantially perpendicular to said motor shaft.

9. The hand-held tool of claim 1, further comprising a convex bearing being coupled to said coupling member and at least said motor shaft or said tool spindle.

10. The hand-held tool of claim 1, wherein said mass balancing arrangement comprises a mass accumulation on said coupling member.

11. The hand-held tool of claim 1, wherein said tool spindle comprises a side arm being configured as a driver fork and being coupled to a bearing mounted on a tool-facing end of said coupling member.

12. A hand-held tool comprising;
a housing;
a gear head received within said housing;
a motor received within said housing and having a motor shaft that is rotatingly driven by said motor;
a tool spindle received within said housing and having one end protruding from said gear head for receiving a tool;
a carrier element received on said housing;
an eccentric coupling mechanism received within said housing, said eccentric coupling mechanism being coupled to said motor shaft and to said tool spindle for driving said tool spindle in an oscillatory rotating manner about a longitudinal axis thereof, said eccentric coupling mechanism comprising a coupling member being configured as a lever or bent lever and being mounted pivotably on said carrier element, said coupling member being coupled to said motor shaft and to said tool spindle.

13. The hand-held tool of claim 12, wherein said coupling member comprises two lever sections between which there is provided a bearing location for supporting said coupling member on said carrier element.

14. The hand-held tool of claim 12, wherein said coupling member is configured as a double fork comprising contact surfaces cooperating with said motor shaft for converting a driving motion produced by said motor shaft into an oscillatory rotary output motion of said tool spindle.

15. The hand-held tool of claim 12, further comprising a convex bearing being coupled to said coupling member and at least said motor shaft or said tool spindle.

16. The hand-held tool of claim 12, wherein said coupling member is arranged pivotably about an axis which is arranged substantially parallel to said motor shaft.

17. The hand-held tool of claim 12, wherein said coupling member is arranged pivotably about an axis which is arranged substantially perpendicular to said motor shaft.

18. The hand-held tool of claim 12, wherein said tool spindle comprises a side arm being configured as a driver fork and being coupled to a bearing mounted on a tool-facing end of said coupling member.

19. A hand-held tool comprising;
a housing;
a gear head received within said housing;
a motor received within said housing and having a motor shaft that is rotatingly driven by said motor;
a tool spindle received within said housing and having one end protruding from said gear head for receiving a tool;
a carrier element received on said housing;
an eccentric coupling mechanism received within said housing, said eccentric coupling mechanism being coupled to said motor shaft and to said tool spindle for driving said tool spindle in an oscillatory rotating manner about a longitudinal axis thereof, said eccentric coupling mechanism comprising a coupling member being configured as a lever or bent lever and being mounted pivotably on said carrier element, said coupling member being coupled to said motor shaft and to said tool spindle.

20. The hand-held tool of claim 19, further comprising a mass balancing arrangement being coupled to said eccentric coupling mechanism and being configured to impart to said eccentric coupling mechanism a balancing motion opposed to an oscillatory rotary output motion of said tool spindle.
